(19) United States
(12) Patent Application Publication
(10) Pub. No.: US 2015/0298991 A1
(43) Pub. Date: Oct. 22, 2015

(54) Water desalination system and method using fresnel lens

(71) Applicant: ERIC LAURENT SALAMA, BOCA RATON, FL (US)

(72) Inventor: ERIC LAURENT SALAMA, BOCA RATON, FL (US)

(21) Appl. No.: 14/722,057

(22) Filed: Jul. 8, 2015

Related U.S. Application Data
(60) Provisional application No. 62/179,034, filed on Apr. 27, 2015.

(51) Int. Cl. C02F 1/14; B01D 3/42

(52) U.S. Cl. CPC C02F 1/14; B01D 3/42; C02F 2103/08

(57) ABSTRACT

A system and method of desalinating saltwater to create potable (drinking) water is disclosed. The system comprises a conically shaped kettle that is heated by sun rays concentrated by use of a plurality of Fresnel lenses to evaporate water from a saltwater source, wherein potable water is recovered from the top of the kettle.

### FIELD OF THE INVENTION

The invention relates to a system and method of desalinating saltwater to create potable (drinking) water. The system comprises a conically shaped kettle that is heated by sun rays concentrated by use of a plurality of Fresnel lenses to evaporate water from a saltwater source, wherein potable water is recovered from the top of the kettle.

### BACKGROUND OF THE INVENTION

Drinking water, also known as potable water or improved drinking water, is water safe enough for drinking and food preparation. Globally, in 2012, 89% of the people had access to water suitable for drinking. Nearly 4 billion had access to tap water while another 2.3 billion had access to wells or public taps. 1.8 billion people still use an unsafe drinking water source which may be contaminated that may result in infectious diseases such as cholera and typhoid. Contaminated water is estimated to result in more than half a million deaths per year.

Typically in developed countries, tap water meets drinking water quality standards, even though only a small proportion is actually consumed or used in food preparation. Reduction of waterborne diseases and development of safe water resources is a major public health goal in developing countries. Bottled water is sold for public consumption in most parts of the world.

Most water requires some type of treatment before use, even water from deep wells or springs. The extent of treatment depends on the source of the water.

Water borne pathogens may be killed or inactivated by boiling but this requires abundant sources of fuel, and can be very onerous on consumers, especially where it is difficult to store boiled water in sterile conditions. Other techniques, such as filtration, chemical disinfection, and exposure to ultraviolet radiation (including solar UV) have been demonstrated to significantly reduce levels of water-borne disease among users in low-income countries, but these suffer from the same problems as boiling methods.

Desalination, or desalinization, are processes that remove salts and minerals from saline water. Salt water is desalinated to produce potable water suitable for human consumption or irrigation. Desalination is used on many seagoing ships and submarines. Currently there is interest in desalination to develop cost-effective ways of providing fresh water for human use. Desalination provides one of the few rainfall-independent water sources.

Due to relatively high energy consumption, costs of desalinating seawater are generally higher than the alternatives (fresh water from rivers or groundwater, water recycling and water conservation), but alternative potable water sources are not always available and rapid overdraw and depletion of reserves is a critical problem worldwide. Quoting Christopher Gasson of Global Water Intelligence, “At the moment, around 1% of the world's population are dependent on desalinated water to meet their daily needs, but by 2025, the UN expects 14% of the world's population to be encountering water scarcity. Unless people get radically better at water conservation, the desalination industry has a very strong future indeed.” See Desalination industry enjoys growth spurt as scarcity starts to bite, available as of Jul. 5, 2015at <http://www.globalwaterintel.com/desalination-industry-enjoys-growth-spurt-scarcity-starts-bite/>.

### SUMMARY OF THE INVENTION

The invention relates to a system and method of desalinating saltwater to create potable (drinking) water. The system comprises a conically shaped kettle that is heated by sun rays concentrated by use of a plurality of Fresnel lenses to evaporate water from a saltwater source, wherein potable water is recovered from the top of the kettle.

The system comprises a conically shaped kettle that is heated by sun rays concentrated by use of a plurality of Fresnel lenses to evaporate water from a saltwater source. The evaporated water is collected with an alembic positioned at the top of the kettle. Potable water is recovered from the kettle and transported into a potable water reservoir. The saltwater is contained in a source reservoir, and is obtained by transporting seawater from an ocean or a sea. The saltwater is sprayed at the inner walls of the kettle which have been heated by the sun. Upon contact, the water evaporates and rises to the top of the kettle where it is collected. The salt, remaining minerals and debris can be collected periodically from the inside of the kettle.

### BRIEF DESCRIPTION OF THE DRAWINGS

FIG. 1 depicts a schematic of a system for desalinating saltwater and recovering potable water according to one embodiment of the invention.

### DETAILED DESCRIPTION OF THE INVENTION

The invention relates to a system and method of desalinating saltwater to create potable (drinking) water. The system comprises a conically shaped kettle that is heated by sun rays concentrated by use of a plurality of Fresnel lenses to evaporate water from a saltwater source, wherein potable water is recovered from the top of the kettle.

The system comprises a conically shaped kettle that is heated by sun rays concentrated by use of a plurality of Fresnel lenses to evaporate water from a saltwater source. In one embodiment, the kettle comprises metal. In one embodiment, the metal comprises iron. The evaporated water is collected with an alembic positioned at the top of the kettle. Potable water is recovered from the kettle and transported into a potable water reservoir. The saltwater is contained in a source reservoir, and is obtained by transporting seawater from an ocean or a sea. The saltwater is sprayed at the inner walls of the kettle which have been heated by the sun. Upon contact, the water evaporates and rises to the top of the kettle where it is collected. The salt, remaining minerals and debris can be collected periodically from the inside of the kettle.

In one embodiment of the invention, saltwater in the source reservoir is heated before being introduced into the kettle. Preheating can be accomplished by flowing the saltwater through a pipe system exposed to the sun by a pump that is solar powered. In one embodiment, the pipes are painted black on the exterior to conduct heat and preheat the saltwater therein. Introduction of preheated saltwater into the kettle will reduce the time to evaporate the water. The sizing of the pipes can be determined by a person skilled in the art without undue experimentation.

The heated saltwater is pumped into the interior of the kettle where it is sprayed onto the interior walls of the kettle. One or more sides of the kettles are heated by the sun using Fresnel lenses. When the sprayed saltwater contacts the hot kettle interior walls, it evaporates.

The water vapor created from the evaporated saltwater is collected with an alembic placed at the apex of the kettle where it is directed by a pipe to a potable water reservoir.

On the exterior of the kettle, a plurality of Fresnel lenses are erected to concentrate the rays of the sun to the exterior walls of the kettle, thus heating them. A Fresnel lens is a compact lens having a large aperture and short focal length by dividing the lens into a set of concentric annular sections.

The Fresnel lenses are mounted on an arm and attached to a mast on top of the kettle. The arm is connected to and controlled by a computer that is programmed to adjust the focus of the lenses based on the path of the sun for the location where the system is constructed. The Fresnel lenses can be rotated by way of bearings, for example.

In one embodiment, a pipeline is constructed from the sea/ocean to the location of the system by any known method of transportation.

The intake pipe going into the sea/ocean will be placed inside of a cage to prevent harm to aquatic wildlife.

The pipelines include sensors to detect leaks or cracks by determining that the amount of saltwater taken in is substantially the same as the amount of saltwater that arrives at the source reservoir. If a discrepancy is determined between the saltwater in and the saltwater that arrives at the source reservoir, the pump at the sea/ocean will shut off automatically.

The pipelines will need expansion rings and flexible rings where needed, and will be constructed from PVC and/or metal. The pipelines will further comprise shut-off valves and anti-seismic shut off sensors when in seismic regions. Each pump will be linked to a gauge and a safety shut off valve so the source reservoir does not overflow.

The saltwater leaving the source reservoir will be pumped towards the kettle through pipes in metal painted in black so it is heated when it arrives at the kettle.

The conically shaped kettles are constructed of iron of a sufficient thickness to not deform or melt in the heat. The kettle will include an access port so that salt and minerals can be extracted, and to allow access to the interior for repairs.

In one embodiment, each kettle will have 3 ft. diameter in ¾ inch thick iron at the base. The kettles should be designed with enough size to recoup small quantities of unevaporated water and but not so large to impede heating of the interior kettle walls.

Saltwater is fed into the interior of the kettle from the bottom and sprayed continuously into the air toward the interior wall of the kettle opposite the exterior that is exposed to the sun rays concentrated by the Fresnel lenses.

The size of Fresnel lenses depend on the size of the conically shaped kettles. The Fresnel lenses are mounted on an arm and attached to a mast on top of the kettle, which arm is attached to a mechanism that is computer controlled to move the Fresnel lenses according to the path of the sun.

The interior of the kettle can be accessed through a port. In one embodiment, the port is located toward the bottom of the kettle along one wall of the kettle. The port allows access to scrape and remove debris such as salt and minerals that are left after evaporation. For example, +/−35 grams of salt come out from a liter of seawater. This salt can be recovered and sold if desired. The recovered salt can be used for commercial purposes. Usable debris can be disposed or used for other purposes if desired, such as building roads.

Energy to operate the pumps and the mechanism to move the Fresnel lenses will be produced by solar panels, making the entire system “green” and sustainable.

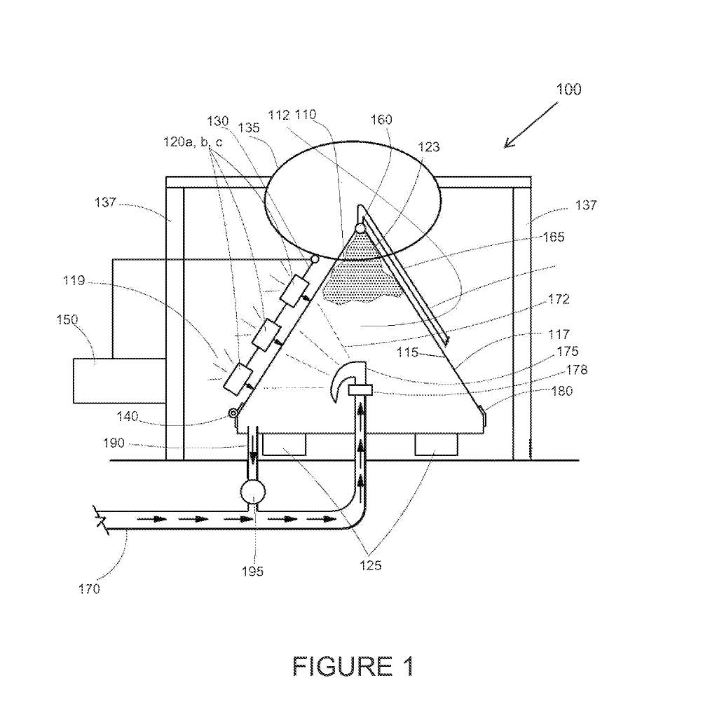

Turning to FIG. 1, a schematic of a system is depicted according to one embodiment of the invention. System 100 comprises a conically shaped kettle 110; a plurality of Fresnel lenses 120a-120c mounted on an arm 130 that is rotated on rail 135 by control of computer 150 at one end of arm 130, where rail 135 is supported by masts 137. Kettle 110 comprises interior wall 115 and an exterior wall 117. Alembic 160 is disposed at the top of kettle 110 to collect evaporated water 123 from the interior of kettle 112. Pipe 165 is attached to the top of alembic 160 to pipe recovered potable water from the interior of kettle 112. Saltwater is pumped into the interior of kettle 112 by pipe 170 through an ejector 175 that sprays the saltwater 172 toward the interior wall of kettle 115 disposed opposite of the exterior wall of kettle 117 to which sunlight 119 is directed by Fresnel lenses 120a-120c. Ejector 175 is controlled by synchronization mechanism 178 to move with the Fresnel lenses 120a-120c. Kettle 110 can be opened at hinge 140 to allow access to interior of kettle 112 to remove salt, other minerals and debris, and to clean interior of kettle 112. Clamp 180 is disposed toward the lower part of kettle 110 to seal kettle 110 shut. Exit pipe 190 is disposed at the bottom of kettle 110 to permit drainage of water from the interior of kettle 112. Pipe 190 includes an anti-reflux valve 195 to prevent saltwater from entering interior of kettle 112. Kettle 110 may be supported at the ground by support devices 125, which may in one embodiment comprise bricks.

1. A system for desalination of water comprising:
an iron conically shaped kettle, the kettle comprising an interior cavity, an apex, a base, an interior wall and an exterior wall;
an alembic disposed at the apex of the kettle comprising an exit pipe;
a plurality of Fresnel lenses disposed on an arm at substantially the same angle, wherein the Fresnel lenses are directed to focus upon the exterior of the wall of the kettle, wherein the arm is connected to the exterior of the kettle at a hinge, wherein further the arm is connected to a computer controlled mechanism to rotate the Fresnel lenses and change the focal point of the lenses;
an inlet pipe introducing saltwater into the interior cavity of the kettle, the inlet pipe comprising an ejector, wherein the ejector is synchronized with the arm to eject incoming saltwater toward the portion of the interior wall of the kettle proximal of the focal points of the Fresnel lenses; and
a hinge disposed at the bottom of the kettle for opening the kettle to allow access to the interior of the kettle,
a clamp disposed at the bottom of the kettle to temporarily lock the kettle shut;
wherein the saltwater ejected from the ejector substantially evaporates upon contacting the heated walls of the kettle proximal of the focal points of the Fresnel lenses,
wherein further the evaporated water rises in the interior of the kettle to the alembic,
wherein further the evaporated water exits the kettle through the exit pipe and is collected as potable water.

2. The system of claim 1, wherein the kettle is three feet in diameter at the base.

3. The system of claim 1, wherein the computer controlled mechanism for the arm and the mechanism for the ejector are solar powered.

4. The system of claim 3, wherein the pump for introducing saltwater into the interior of the kettle is solar powered.

5. A method of desalinating water, comprising:
transporting saltwater to a desalination system;
storing the saltwater in a source reservoir;
pumping saltwater from the source reservoir into the desalination system; and
removing desalinated potable water from the desalination system,
wherein the desalination system comprises the system according to claim 1.

6. The method of claim 3, wherein the saltwater is transported from an ocean.

7. The method of claim 3, wherein the saltwater is transported from a sea.

8. The method of claim 3, wherein the salt recovered from the interior of the kettle is sold for commercial purposes.

9. The method of claim 3, wherein the saltwater is transported in pipes, wherein the pipes comprise sensors to compare the amount of saltwater introduced into the pipes with the amount of saltwater that arrives at the source reservoir and a solar powered shut-off valve, wherein a discrepancy that exceeds a predetermined value causes the shut-off valve to close.
